(19) United States
(12) Patent Application Publication
(10) Pub. No.: US 2007/0220474 A1
(43) Pub. Date: Sep. 20, 2007

(54) Method for facilitating power/ground wiring in a layout

(76) Inventors: Yu-Chuan Chang, Taipei (TW); Yi-Hsin Hsieh, Taipei (TW)

Correspondence Address: HARNESS, DICKEY & PIERCE, P.L.C., P.O. BOX 8910, RESTON, VA, 20195, US

(21) Appl. No.: 11/374,965

(22) Filed: Mar. 15, 2006

(51) Int. Cl. G06F 17/50

(52) U.S. Cl. 716/15; 716/12

(57) ABSTRACT

A method for facilitating the power/ground wiring in layout is provided, which comprises searching more than one power line or more than one ground line according to the key words of the line names; specifying the power lines correspond to a power layer or the ground lines correspond to a ground layer; setting the power layer or the ground layer to be a line layer to be wired; selecting the line layer to be wired; and indicating the corresponding power lines of the power layer or the corresponding ground lines of the ground layer with special indication effects according to the line layer to be wired, thereby avoiding neglect.

### BACKGROUND OF THE INVENTION

1. Field of Invention

The present invention relates to a method for facilitating wiring in a computerized printed circuit board, and more particularly to a method for facilitating the power/ground wiring in a layout.

2. Related Art

During the design of the printed circuit board, previous computer graphic design is one of the important works, wherein the operation of computerizing the printed circuit board mainly comprises two parts, including a preplacement operation, and a subsequent layout operation.

For example, if the wiring diagram contains a circuit board structure having eight layers of boards, four layers for signal lines wiring and the other four layers for power lines and ground lines, a layout operator will carry out a wiring process for each layer of lines by plotting by layers, and then integrating individual wiring diagrams as one diagram, such that the wiring operation is accomplished. Therefore, it can be seen that if the power lines and the ground lines can be processed first, the remaining signal lines will be processed relatively easily.

The wiring process of the power lines or the ground lines are performed manually by the layout operators, in which each power line or ground line are highlighted, so as to plot vias, adjust wiring, and so on. As such, when some parts are neglected to be processed, the wiring state of the lines needs to be adjusted again, and thus it is time consuming and inefficient.

Referring to ROC patent publication No. 540273, a method for indicating the state of trace applied in a layout is disclosed, in which a trace selection is made to input a limited range of length, and based on a path a cursor passes, a length of the path is obtained. After comparing the two lengths, when the obtained length of the layout does not fall in the limited range of the length, the traces are highlighted. The above method can allow the layout operator to quickly find out the traces of a length fallen in the limited range of length, and thereby overcome the problem of computation error caused by the operator, but it cannot be used to perform searching and indicating for the power line and the ground line.

Referring to ROC patent publication No. 577248, a method for arranging trace applied in a layout is disclosed, which relates to plotting traces or vias again based on the trace primarily plotted according to a reference setting.

With the above method, the alignment of the traces and the vias can be arranged quickly, thereby accelerating layout engineering. However, in the primary period of plotting the wiring diagram, due to the over-complicated lines, some lines may also be neglected. Therefore, the above problem still cannot be solved.

Therefore, it becomes one of the problems to be solved for the researchers that how to provide a method for facilitating the power/ground wiring in a layout for filtering and indicating all power/ground lines automatically, such that the problem of neglecting the process can be avoided.

### SUMMARY OF THE INVENTION

In view of the above problems, a main object of the present invention is to provide a method for facilitating the power/ground wiring in a layout, which relates to marking a power line and a ground line with a special indication effect for the layout operator to make a quick selection and carry out wiring operation, thereby avoiding the problem of neglecting the process.

Therefore, in order to achieve the above object, the method for facilitating the power/ground wiring in a layout disclosed in the present invention comprises searching more than one power line or more than one ground line according to the key words of the line names at first; specifying the power lines found correspond to a power layer, or specifying the ground lines found correspond to a ground layer; setting the power layer or the ground layer to be a line layer to be wired; selecting the line layer to be wired; and indicating the corresponding power lines of the power layer or the corresponding ground lines of the ground layer with a special indication effect (for example, changing the indication color, glittering the wiring, or thickening the wiring), according to the line layer to be wired, for the layout operators to make a quick selection. Moreover, in order to achieve the above object, the method for facilitating the power/ground wiring in a layout disclosed in the present invention comprises establishing the relationship between more than one power line and more than one power layer, and establishing the relationship between more than one ground line and more than one ground layer at first; setting the power layer or the ground layer to be a line layer to be wired; selecting the line layer to be wired; and indicating the corresponding power lines of the power layer or the corresponding ground lines of the ground layer with a special indication effect (for example, changing the indication color, glittering the wiring, or thickening the wiring), according to the line layer to be wired.

With the method for facilitating the power/ground wiring in a layout, all power lines and ground lines are highlighted automatically through the program, such that the layout operators can deal with the power lines and ground lines first, thereby avoiding the problem of neglecting the process.

The characteristics and practices related to the present invention will be described in detail in the preferred embodiments in accompany with drawings. Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and which thus is not limitative of the present invention, and wherein:

FIG. 1A shows a flow chart of a method for facilitating the power/ground wiring according to a first embodiment of the present invention;

FIG. 1B shows a flow chart of a method for facilitating the power/ground wiring according to a second embodiment of the present invention; and

FIG. 2 shows a schematic view of an operation picture according to the second embodiment of the present invention.

### DETAILED DESCRIPTION OF THE INVENTION

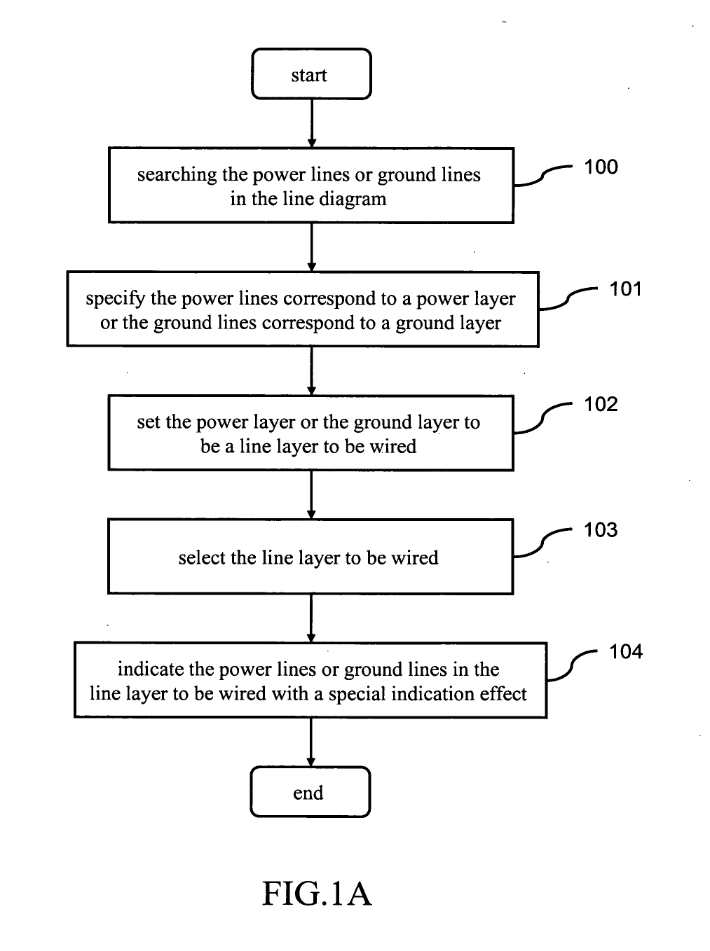

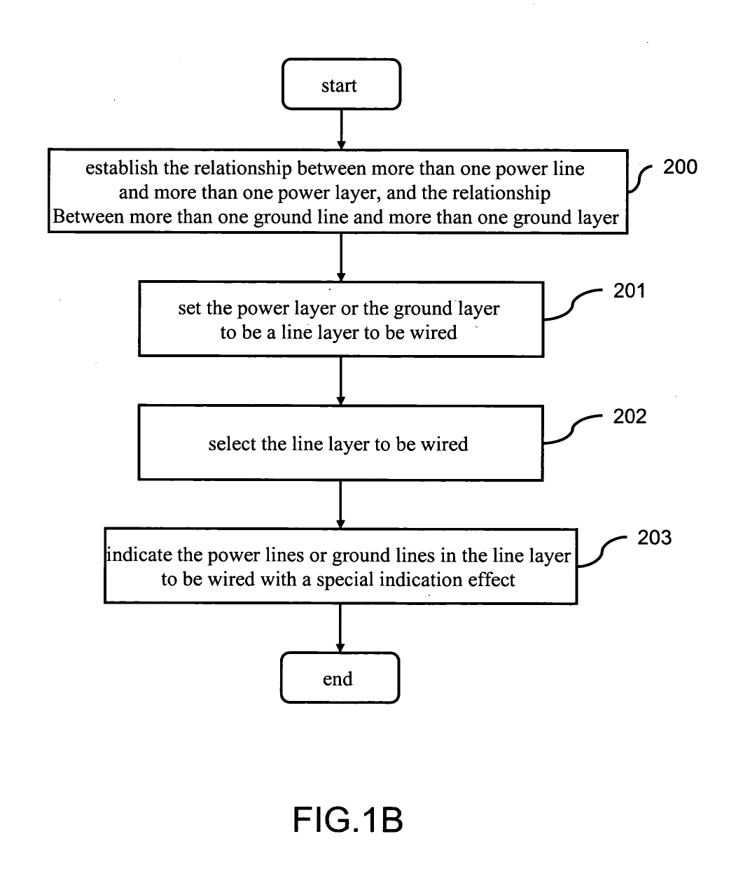

Referring to FIG. 1A, it shows a flow chart of a method for facilitating the power/ground wiring according to a first embodiment of the present invention. The method comprises searching more than one power line or more than one ground line in a line diagram at first (step 100), wherein the power lines or the ground lines are found through searching the lines with line names containing “+V”, “+” or “GND”, and additionally the layout operators can set the searching condition (key words) to adjust the searching sensitivity; next, specifying the power line found to a power layer, or specifying the s ground line found to a ground layer (step 101), i.e., integrating the data of the power line into the data of the power layer, such that the data of the power line and the data of the power layer are combined, and similarly integrating the data of the ground line into the data of the ground layer, such that the data of the ground line and the data of the ground layer are combined.

The power layer or the ground layer are set to be a line layer to be wired (step 102), i.e. the power layer or the ground layer are converted to a data format of the line layer to be wired for the layout operator to select. Then, the layout operators select the line layer to be wired (step 103). According to the selected line layer to be wired, call the corresponding power line data and circuit layer data, or the corresponding ground line data and ground layer data, and indicate the corresponding power line of the power layer or the corresponding ground line of the ground layer with a special indication effect (step 104), wherein the special indication effect refers to highlighting, and the highlighting can be changing the indication color, glittering the wiring, or thickening the wiring.

As such, when the layout operator selects the power layer (ground layer) which will be wired, the layout software will highlight the corresponding power line (ground line) in the power layer (ground layer) for the layout operator to select and perform wiring operation.

Referring to FIG. 1B, it shows a flow chart of a method for facilitating the power/ground wiring according to a second embodiment of the present invention. The method comprises establishing the relationship between more than one power line and more than one power layer, and the relationship between more than one ground line and more than one ground layer (step 200), wherein the line data and the power layer data or the ground layer data are combined according to the line name or the line type, so as to establish the relationship.

The power layer or the ground layer is set to be a line layer to be wired (step 201), i.e. the power layer or the ground layer is converted into the data format of line layer to be wired for the layout operator to select. Then, the layout operator selects the line layer to be wired (step 202). According to the line layer to be wired, call the corresponding power line data and circuit layer data, or the ground line data and ground layer data, and indicate the corresponding power line of the power layer or the corresponding ground line of the ground layer with a special indication effect (step 203), wherein the special indication effect refers to highlighting, and the highlighting can be changing the indication color, glittering the wiring, or thickening the wiring.

Thus, when the layout operator selects the power layer (ground layer) which is to be wired, the layout software will highlight the corresponding power line (ground net) in the power layer (ground layer) for the layout operator to select and perform the wiring operation.

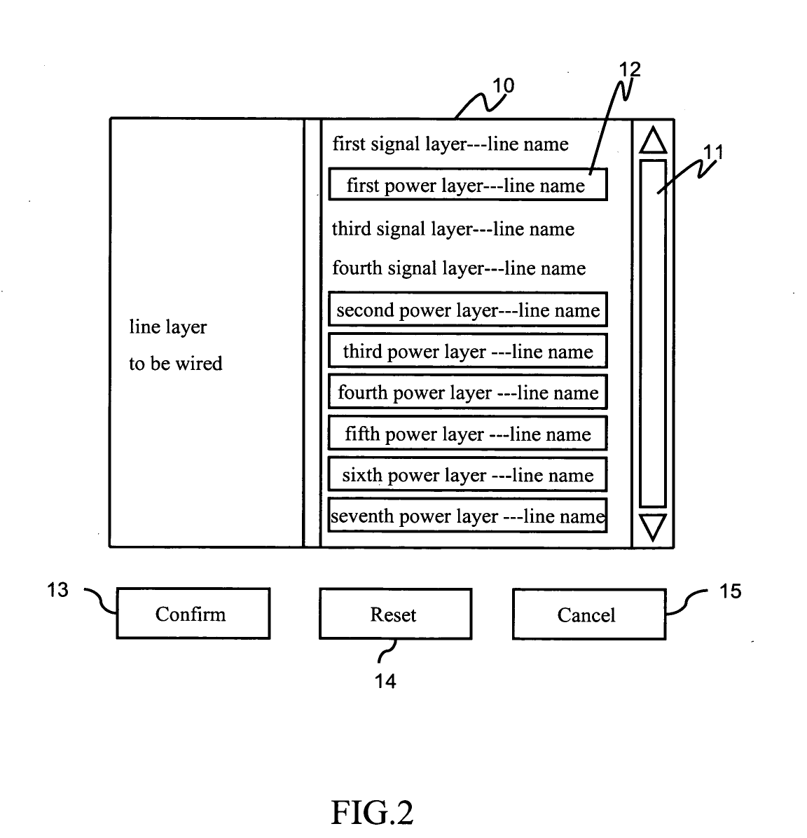

Referring to FIG. 2, it shows a schematic view of an operation picture according to the second embodiment of the present invention. First, the data of multiple line layers to be wired are displayed in an edit window 10, and the layout operators select the line layers to be wired through a scroll 11 and a check box 12: first power layer - - - line name, for example, “POWER_{—}1 - - - DGND(L2)”, second power layer - - - line name, for example, “POWER_{—}2 - - - +NB_CORE”, third power layer - - - line name, for example, “POWER_{—}3 - - - +V3S”, fourth power layer - - - line name, for example, “POWER_{—}4 - - - +V3A”, etc. When the layout operator has made a wrong selection, he/she can press a Reset key 14 or a Cancel key 15 to reselect the line layer to be wired. After finishing the selection, the layout operator presses a Confirm key 13, then the system will highlight the lines automatically except other lines (e.g. signal line or ground line). Thus, the wiring edit picture of the whole line diagram will clearly show the lines to be wired currently, and thereby the layout operator can carry out the wiring of power line, ground line, and signal line in sequence. Therefore, the quality of the layout is further improved.

With the method for facilitating the power/ground wiring in a layout, all power lines and ground lines are highlighted automatically through the program, such that the layout operator can process the power lines and ground lines first, to avoid the problem of neglecting the process.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for facilitating the power/ground wiring in a layout, comprising:
searching more than one power line or more than one ground line according to key words of a line name;
specifying the power lines correspond to a power layer or the ground lines correspond to a ground layer;
setting the power layer or the ground layer to be a line layer to be wired;
selecting the line layer to be wired; and
indicating the corresponding power lines of the power layer or the corresponding ground lines of the ground layer with a special indication effect according to the line layer to be wired.

2. The method for facilitating the power/ground wiring in a layout as claimed in claim 1, wherein the special indication effect is highlighting.

3. The method for facilitating the power/ground wiring in a layout as claimed in claim 2, wherein the highlighting is selected from any combination of changing indication color, glittering the wiring, and thickening the wiring.

4. A method for facilitating the power/ground wiring in a layout, comprising:
establishing the relationship between more than one power line and more than one power layer, and the relationship between more than one ground line and more than one ground layer;
setting the power layers or the ground layers to be line layers to be wired;
selecting the line layer to be wired; and
indicating the corresponding power lines of the power layers or the corresponding ground lines of the ground layers with a special indication effect according to the line layer to be wired.

5. The method for facilitating the power/ground wiring in a layout as claimed in claim 4, wherein the power line and the power layer are combined to establish a relationship according to a line name or a line type.

6. The method for facilitating the power/ground wiring in a layout as claimed in claim 4, wherein the ground line and the ground layer are combined to establish the relationship according to a line name or a line type.

7. The method for facilitating the power/ground wiring in a layout as claimed in claim 4, wherein the special indication effect is highlighting.

8. The method for facilitating the power/ground wiring in a layout as claimed in claim 7, wherein the highlighting is selected from any combination of changing indication color, glittering the wiring, and thickening the wiring.
